(19) United States
(12) Patent Application Publication
(10) Pub. No.: US 2013/0121795 A1
(43) Pub. Date: May 16, 2013

(54) TWO SPEED CRANK ELEVATOR HAND TRUCK WITH RETRACTABLE SKATEBOARD

(71) Applicant: Phong Le, San Jose, CA (US)

(72) Inventor: Phong Le, San Jose, CA (US)

(21) Appl. No.: 13/296,712

(22) Filed: Nov. 15, 2011

(51) Int. Cl. B62B 1/12; B60P 1/02; B62B 3/02

(52) U.S. Cl. 414/490; 414/812; 414/495

(57) ABSTRACT

A hand truck with manual multiple speed elevator and attachable retractable skateboard.

### BACKGROUND

### Field of the Invention

The present invention generally relates to hand trucks for loading, stacking, tilting and moving objects manually. More specifically, the invention relates to hand trucks for porting objects without manual lifting to load and unload the hand truck.

Conventional hand trucks for manual hauling of payloads, such as goods in boxes, appliances, packages, sacks, and so on, onto and off of delivery trucks and into storage areas, have given way to more automated and power assisted hand trucks. Moreover, manual manipulation of hand trucks onto or off of a delivery truck is often back debilitating work requiring two or more people to physically perform the lowering, or lifting of the hand truck supported payload, particularly when lifting large, heavy payloads.

Some assistance to the problems outlined above with respect to the use of manual hand trucks has been provided for by powered hand trucks. However these have inherent cost and portability disadvantages. No free lunch means that as more power is added to the hand truck, the truck's weight increases as well as maneuverability in small areas, not to mention the additional cost. Because some hand trucks are infrequently used, their costs outweighs the utility cost demanded by purchase. Thus there is still a need for relatively light and inexpensive hand trucks that can help loaders to lift heavy objects without injury.

What is needed are lightweight relatively inexpensive hand trucks with aid for lifting and loading otherwise back breaking loads.

### SUMMARY

The present invention discloses a system for a multi-threaded worm for raising an elevator on a hand truck for loading, moving, stacking and lifting objects at select speeds. This is comprise of a frame of rigid structures coupled to a perpendicular more or less flat support base assembly translatable along the frame axis. The frame has handles rigidly fixed more-or-less perpendicular to the frame and wheels mounted to frame providing for movable load transfer over ground. The frame axis is aligned with multi-threaded worm housed in a cylindrical guide rigidly coupled to the frame, the worm coupled to a worm gear for elevating surface. The worm screw is operatively coupled to the base assembly for lifting base surface along the frame axis with guide with a worm gear box housing the worm gear, housing rigidly coupled to the worm cylinder. A manual switch mechanism for selectively coupling worm thread channels for turning the worm thread channel to the worm gear is included rotably coupling a crank handle to the worm gear for manual cranking. An elevating base lift support along the frame axis elevates by application of torque to the crank handle through the manual switch mechanism.

The hand truck can also have an attached skateboard at the elevator frame end of the frame, skateboard having at least two wheels.

### BRIEF DESCRIPTION OF DRAWINGS

Specific embodiments of the invention will be described in detail with reference to the following figures.

FIG. 1 is an illustration showing a basic frame structure for a multi-speed elevator hand truck with elevator assembly according to an embodiment of the present invention.

FIG. 2 is a side view illustration of a basic frame structure with wheels and handles in accordance with an embodiment of the invention.

FIG. 3 is a side view illustration the multi-screw worm and switching assembly for a multi-speed lift hand truck in accordance with an embodiment of the invention.

FIG. 4 is a side view diagram for the worm screw thread switch mechanism for a multi-speed lift hand truck in accordance with an embodiment of the invention.

FIG. 5 is a top view of the manual crank worm gear mechanism for a two-speed lift hand truck in accordance with an embodiment of the invention.

FIG. 6 is a cut top view of the a multi-speed lift hand truck in accordance with an embodiment of the invention.

FIG. 7 is a partial front and side view of a multi-speed lift hand truck with attached skateboard in accordance with an embodiment of the invention.

FIG. 8 shows a a bottom view of the truck socket coupler to skateboard in accordance with an embodiment of the invention.

FIG. 9 illustrates a retractable skateboard coupled to a manual hand truck in accordance with an embodiment of the invention.

FIG. 10 illustrates a retractable skateboard coupled to a one wheel manual hand truck in accordance with an embodiment of the invention

### DETAILED DESCRIPTION

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

### OBJECTS AND ADVANTAGES

The present invention discloses hand truck embodiments for lifting, loading, stacking, tilting and moving objects manually.

An object of the invention is to create light weight hand trucks for porting objects with reduced manual lifting.

It is another object of the invention is to create light hand trucks for lifting loads at more than one rate of speed, in accordance to the load weight.

It is yet another object of the invention to provide an element of fun to an otherwise repetitive job.

Accordingly, it is an object of the present invention to provide an inherent cost for portability advantages as well as retaining maneuverability in small areas.

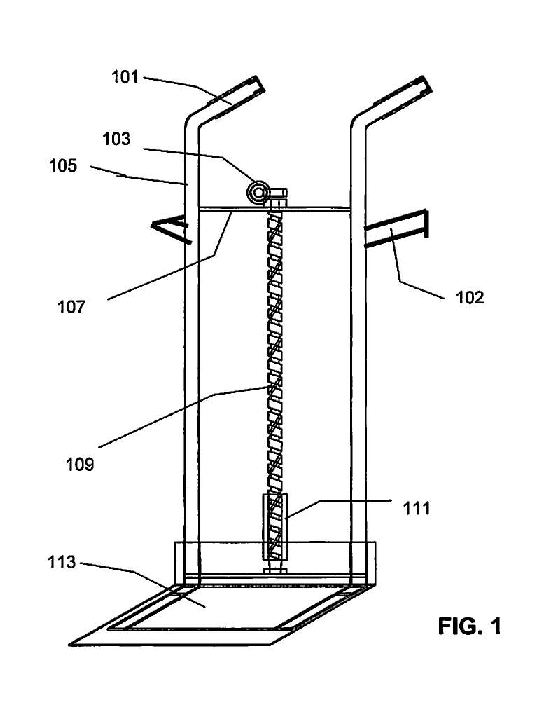

FIG. 1 is an illustration showing a basic frame structure for a multi-speed elevator hand truck with elevator assembly according to an embodiment of the present invention. FIG. 1 show a multi-threaded worm 109 for raising an elevator 113 on a hand truck 105 for loading, moving, stacking and lifting objects at select speeds.

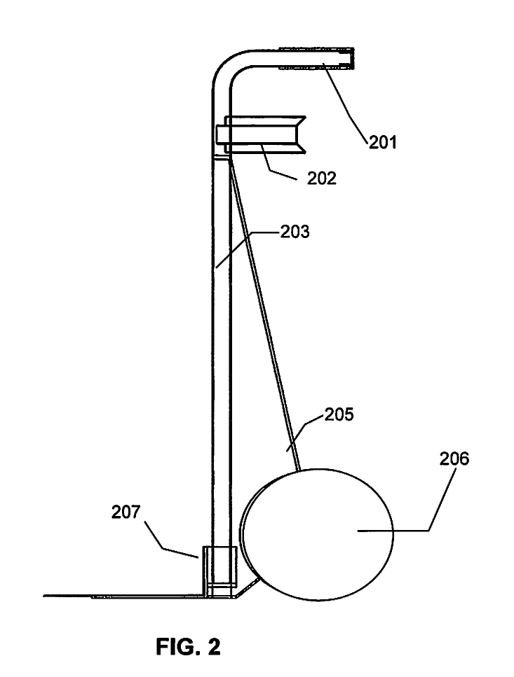

The components include a frame of rigid structures 105 107 coupled to a perpendicular more or less flat support base 113 assembly translatable along the frame 105 axis. The frame 105 107 has handles 101 102 rigidly fixed more-or-less perpendicular to the frame 105 107. Wheels are mounted to frame, shown in FIG. 2, providing for movable load transfer over ground. The frame axis is aligned with multi-threaded worm 109 housed in a cylindrical guide rigidly coupled to the frame, the worm coupled to a worm gear for elevating surface 113. The worm 109 screw is operatively coupled to the base assembly 111 for lifting base surface 113 along the frame axis with guide. A worm gear box 103 housing the worm gear is rigidly coupled to the worm cylinder.

A manual switch mechanism is used for selectively coupling worm thread channels for turning the worm thread channel to the worm gear. A hand crank is rotatably coupled to the worm gear for manual cranking. Hand cranking will elevate the base 113 elevator supported along the frame axis by application of torque to the crank handle through the manual switch mechanism 111.

The frame can be made from a set of materials consisting of metal, plastic, rubber, man-made composites and wood. The materials are chosen for light weight and strength in supporting the design loads.

FIG. 2 is a side view illustration of a basic frame structure 203 205 with wheels 206 and handles 201 202 in accordance with an embodiment of the invention. The handles 201 and 202 can have various placement levels and multiple degrees of freedom. The wheels 206 can be positioned in various ways to the frame 203. The worm guide is coupled to a selectable locking bolt mechanism 207 for slidably connecting a worm gear to thread channel slidable bolt riding one of a plurality of worm thread channels.

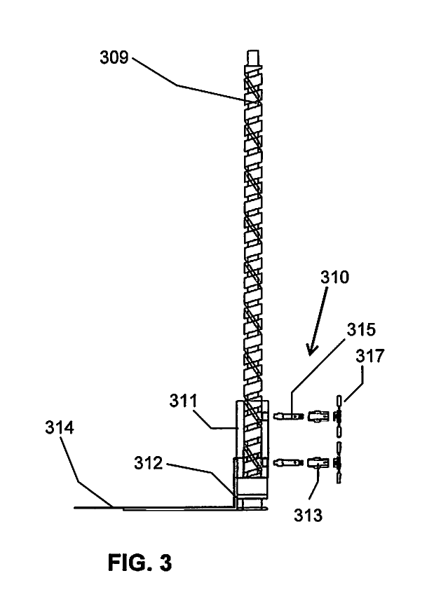

FIG. 3 is a side view illustration the multi-screw worm 309 and switching assembly 310 for a multi-speed lift hand truck in accordance with an embodiment of the invention. The worm 309 fits into a housing guide 311, only partially drawn. The elevator 314 is coupled to the worm 309 via the switching mechanism housing 312. The switching mechanism shown is a simple slider 315 and spring release 313 coupled to a turning handle 317 which turn-pushes a slider 315 into the selected worm 309 groove or thread channel. The worm 309 screw is operatively coupled to the base assembly 314 for lifting base surface 314 along the frame axis with guide.

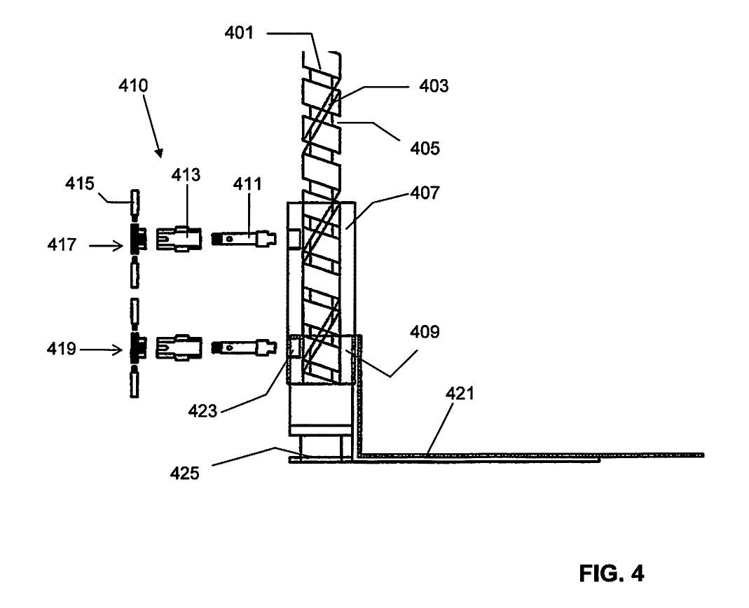

FIG. 4 is a side view diagram for the worm screw thread switch mechanism for a multi-speed lift hand truck in accordance with an embodiment of the invention. The worm 401 is shown with two thread channels 403 405 which is housed in a guide 407 coupled to the base 423. The channel selector mechanism 417 419 allow for two elevator speeds by manual selection. An outside cylindrical elevator 421 lifter 409 contains openings 423 for the thread or groove channel selector slidable spring 413 slider bar 411, and supports the slider 411 in the selected worm thread channel 403 405 as the worm 401 turns. The slider select mechanism couples the elevator 421 upward motion along the worm 401 axis along the selected thread channel 403 405. The worm 401 guide 425 is rigidly coupled to the frame.

The frame axis aligned multi-threaded worm 401 is housed in a cylindrical guide 407 rigidly coupled to the frame 425, the worm 401 coupled to the worm gear for screwing the elevator surface 421 along the worm 401 axis.

The manual switch mechanism 410 for selectively coupling worm thread channels 403 405 operatively aligns the worm thread channel to the worm gear which is manually cranked turning the worm gear. This in turn elevates the base lift elevator 421 along the frame axis by application of torque to the crank handle via the manual switch mechanism 410.

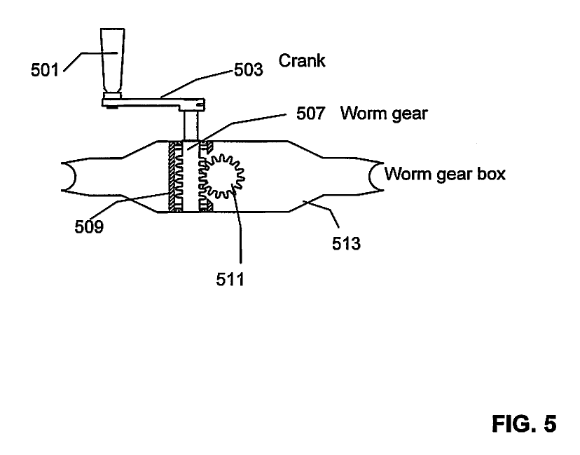

FIG. 5 is a top view of the manual crank 501 worm gear 509 mechanism for a multi-speed lift hand truck in accordance with an embodiment of the invention. A worm gear box 513 housing a worm gear 511, housing 513 is rigidly coupled to a worm guide cylinder housing the worm 511. The worm gear 511 is rotably coupled to a crank 503 handle 501 providing transmission of power to the worm gear 509 from manual cranking 501, translating screw to the worm 511.

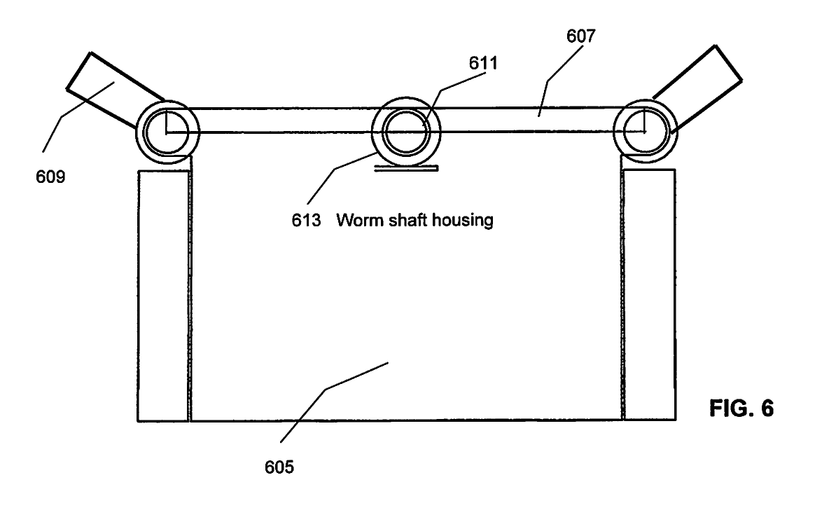

FIG. 6 is a cut top view of the a multi-speed lift hand truck in accordance with an embodiment of the invention. Looking down on a vertically aligned frame 607 shows a frame axis aligned cross-section of multi-threaded worm 611 housed in a cylindrical worm guide 613, the worm 611 inside the guide 613 is operatively coupled to a worm gear, not shown here, for lifting elevator 605 via hand crank, translating lift along the frame axis. Handles 609 are coupled to the frame 607 with horizontal and radial degrees of freedom to increase user flexibility and handling ease.

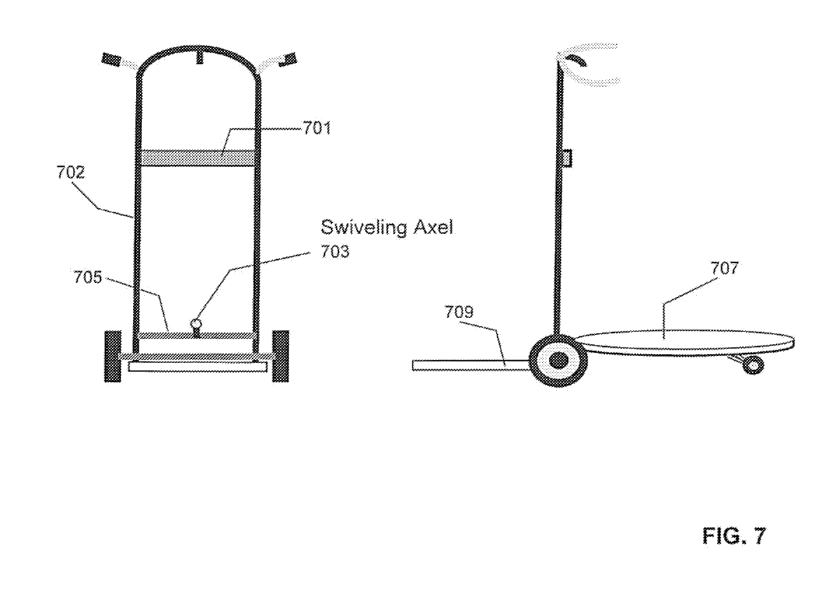

FIG. 7 is a partial front and side view of a multi-speed elevator hand truck with attached skateboard 707 in accordance with an embodiment of the invention.

The truck frame 702 has a cross structure 705 as near the elevator 709 end with a coupler 703 for a skateboard 707 having at least two wheels. Another frame cross structure 701 supports a clip attachment.

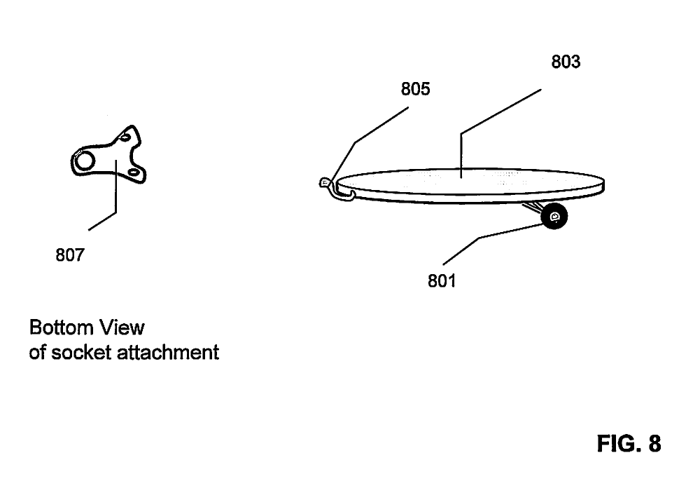

FIG. 8 shows a a bottom view of the truck socket coupler to skateboard in accordance with an embodiment of the invention. The skateboard 803 coupling end has a component 807 for attaching to the hand truck frame. This can be a ball and socket 703 for coupling the skateboard attachment component 807 to the attachment component 805 end to the truck frame such that the skateboard 803 can be slip click attached and detached by user. A slidable coupling component on a frame cross bar allowing two degrees of freedom, generally in the horizontal plane, to the attached skateboard end 805 can also be used as well as other motion restraining attachment devices.

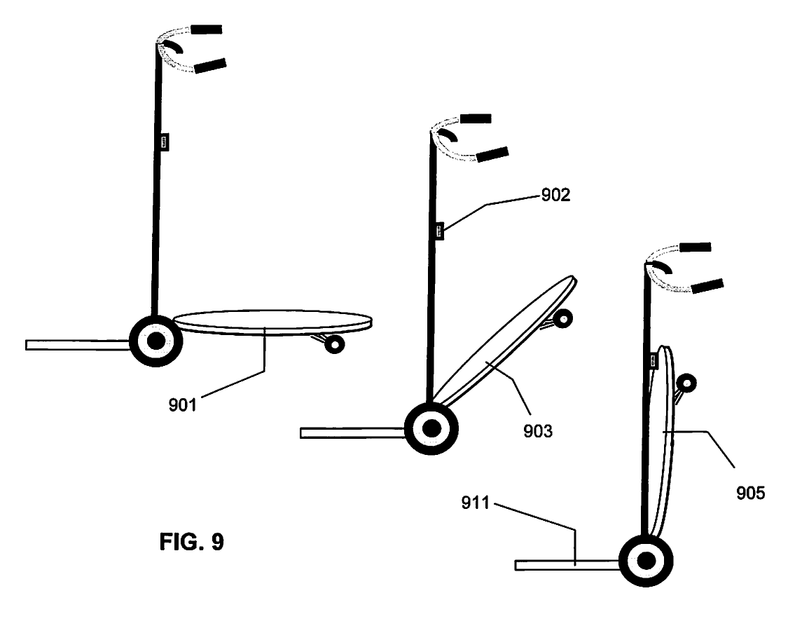

FIG. 9 illustrates a retractable skateboard 901 903 905 coupled to a manual hand truck in accordance with an embodiment of the invention. The skateboard 901 903 905 is coupled to the frame such that the skateboard can be rotatably retracted and secured to the frame with slip clicking attachment device 902.

The method of coupling the skateboard frame attachment end to the frame such that the skateboard can be attached and detached by user using many off the shelf quick release attachment components such as snaps, clips, latches, clamps, couplers, fasteners, mechanisms, and others devices.

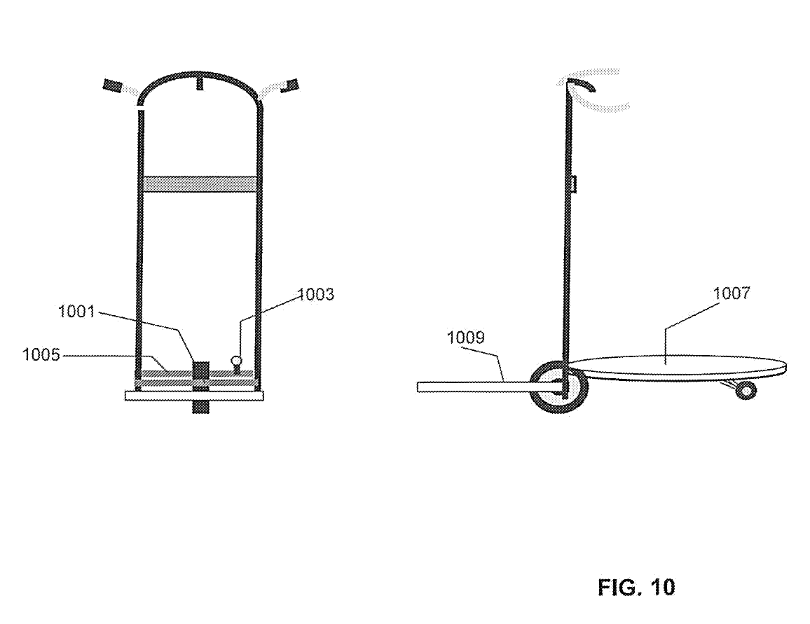

FIG. 10 illustrates a retractable skateboard 1007 coupled to a manual hand truck with one wheel 1001 in accordance with an embodiment of the invention. The frame cross bar 1005 has a coupler 1003 for attaching a skateboard 1007 and having a payload shelf or elevator 1009 for transporting payload.

Therefore, while the invention has been described with respect to a limited number of embodiments, those skilled in the art, having benefit of this invention, will appreciate that other embodiments can be devised which do not depart from the scope of the invention as disclosed herein. Other aspects of the invention will be apparent from the following description and the appended claims.

What is claimed is:

1. A method for loading, stacking, tilting, moving and lifting objects via a multi-threaded worm mechanism hand truck elevator further comprising the steps of:
constructing a rigid frame structure coupled to a more or less perpendicular rigid base elevator assembly translatable along the frame axis;
assembling the base elevator translatably coupled to the frame axis;
coupling handles to the frame;
mounting wheels to frame providing truck load translation;
rigidly coupling a frame axis aligned multi-threaded worm housed in a cylindrical worm guide, the worm inside the guide operatively coupled to a worm gear for lifting elevator via hand crank, translating lift along the frame axis;
rigidly coupling a worm gear housing to the worm guide, worm gear housing containing gear coupled to selectable switching mechanism coupling worm gear to selectable worm thread channels for turning the worm at selected speeds;
coupling a selectable locking bolt mechanism for slidably connecting a worm gear to thread channel slidable bolt riding one of a plurality of worm thread channels;
coupling a rotatable crank handle to the worm gear for manual cranking; and
elevating the elevator along the frame axis by application of torque to the crank handle after selection of worm thread channel.

2. The method as in claim 1 wherein the frame is made from a set of materials consisting of metal, plastic, rubber, man-made composites and wood.

3. The method as in claim 1 further comprising the steps of attaching a skateboard with at least two wheels to the elevator end of the frame.

4. The method as in claim 3 further comprising the step of rotatably coupling the skateboard frame attachment end to the frame such that the skateboard can be retracted and secured to the frame.

5. The method as in claim 3 further comprising the step of coupling the skateboard frame attachment end to the frame such that the skateboard can be attached and detached by user.

6. A multi-threaded worm for raising an elevator on a hand truck, loading, moving, stacking and lifting objects at select speeds comprising:
a frame of rigid structures coupled to a perpendicular more or less flat support base assembly translatable along the frame axis;
the frame with handles rigidly fixed more-or-less perpendicular to the frame;
wheels mounted to frame providing for movable load transfer over ground;
the frame axis aligned multi-threaded worm housed in a cylindrical guide rigidly coupled to the frame, the worm coupled to a worm gear for elevating surface:
the worm screw operatively coupled to the base assembly for lifting base surface along the frame axis with guide;
a worm gear box housing the worm gear, housing rigidly coupled to the worm cylinder, manual switch mechanism for selectively coupling worm thread channels for turning the worm thread channel to the worm gear;
ratably coupling a crank handle to the worm gear for manual cranking; and
elevating base lift support along the frame axis by application of torque to the crank handle through the manual switch mechanism.

7. The multi-threaded lifting elevator hand truck as in claim 6 wherein the materials for the truck are from a set of materials consisting of metal, plastic, rubber, man-made composites and wood.

8. A multi-threaded worm for raising an elevator on a hand truck as in claim 6 further comprising an attached skateboard at the elevator end of the frame, skateboard having at least two wheels.

9. A multi-threaded worm for raising an elevator on a hand truck as in claim 6 further comprising a rotatably coupled skateboard to frame whereby the skateboard can be rotatably retracted and secured to the frame.

10. A multi-threaded worm for raising an elevator on a hand truck as in claim 6 further comprising a rotatably coupled skateboard to frame such that the skateboard can be attached and detached by user.

11. The method as in claim 3 further comprising the step of coupling the skateboard frame attachment end to the frame such that the skateboard can be attached and detached by user.

12. A manual hand truck for loading, moving, stacking and lifting objects comprising:
a frame of rigid structures coupled to a perpendicular more or less flat support base assembly translatable along the frame axis,
the frame with user adjusting handles with angular degree of freedom affixed more-or-less perpendicular to the frame;
at least one wheel mounted to the frame for translating payload, and
an attached skateboard at the truck wheel end of the frame, skateboard having at least one wheel,
whereby a user can recreate while operating the hand truck.

13. The manual hand truck as in claim 12 further comprising a rotatably coupled skateboard which is can be rotated about the truck wheel axis and secured to the frame.

14. The manual hand truck as in claim 12 further comprising a slidably or rotatably coupled skateboard such that the skateboard can be attached and detached by user.
